(19) United States
(12) Patent Application Publication
(10) Pub. No.: US 2023/0187986 A1
(43) Pub. Date: Jun. 15, 2023

(54) ROTOR, MOTOR, COMPRESSOR, AND REFRIGERATION CYCLE APPARATUS

(71) Applicant: Mitsubishi Electric Corporation, Tokyo (JP)

(72) Inventors: Yuji HIROSAWA, Tokyo (JP); Masahiro NIGO, Tokyo (JP)

(21) Appl. No.: 18/003,177

(22) PCT Filed: Jul. 28, 2020
(86) PCT No.: PCT/JP2020/028798

§ 371 Date: Dec. 23, 2022

(51) Int. Cl. H02K 1/276; C09K 5/04

(52) U.S. Cl. CPC H02K 1/276; C09K 5/045; C09K 2205/126

(57) ABSTRACT

A rotor includes a rotor core having an outer circumference extending in a circumferential direction about an axis and a magnet insertion hole located on an inner side of the outer circumference in a radial direction about the axis, and a permanent magnet inserted in the magnet insertion hole. The rotor core has a flux barrier at an end of the magnet insertion hole in the circumferential direction. At least a part of the flux barrier is located on the outer circumference side of a magnetic pole face of the permanent magnet. In the rotor core, an inter-pole portion is defined on an outer side of the magnet insertion hole in the circumferential direction. A groove portion is formed on the inter-pole portion side of the flux barrier in the circumferential direction. The groove portion is recessed inward in the radial direction from the outer circumference. The groove portion faces the flux barriers in the circumferential direction. The flux barrier has a concave portion formed on an inner side of the groove portion in the radial direction.

### CROSS-REFERENCE TO RELATED APPLICATION

This application is a U.S. National Stage Application of International Application No. PCT/JP2020/028798 filed on Jul. 28, 2020, the contents of which are incorporated herein by reference.

### TECHNICAL FIELD

The present disclosure relates to a rotor, a motor, a compressor, and a refrigeration cycle apparatus.

### BACKGROUND

In a motor having a permanent magnet embedded in a rotor, a voltage is induced in a coil of a stator due to magnetic field of the permanent magnet during rotation of the rotor. This voltage is called an induced voltage.

For the purpose of rotating a motor at high speed with high efficiency, there is a case where field-weakening control is performed (see, for example, Patent Reference 1). When the field-weakening control is performed, a short circuit of magnetic flux is likely to occur between magnetic poles of the rotor, and harmonics of the induced voltage is likely to occur. When the harmonics of the induced voltage occurs, torque ripple occurs, and the vibration of the motor increases.

### PATENT REFERENCE

Patent Reference 1: International Publication WO 2019/174579 (see, paragraphs 0017-0019 and FIG. 1)

Thus, in order to suppress vibration of the motor, it is required to reduce the torque ripple of the motor.

### SUMMARY

The present disclosure is intended to solve the above-described problem, and an object of the present disclosure is to reduce torque ripple of a motor.

A rotor according to the present disclosure includes a rotor core having an outer circumference extending in a circumferential direction about an axis, and having a magnet insertion hole located on an inner side of the outer circumference in a radial direction about the axis, and a permanent magnet inserted in the magnet insertion hole. The rotor core has a flux barrier at an end of the magnet insertion hole in the circumferential direction. At least a part of the flux barrier is located on the outer circumference side of a magnetic pole face of the permanent magnet. A positioning portion that positions the permanent magnet in the magnet insertion hole is formed adjacent to the flux barrier. In the rotor core, an inter-pole portion is defined on an outer side of the magnet insertion hole in the circumferential direction. A groove portion is formed on the inter-pole portion side of the flux barrier in the circumferential direction. The groove portion is recessed inward in the radial direction from the outer circumference. The groove portion faces the flux barrier in the circumferential direction. The flux barrier has a concave portion formed on an inner side of the groove portion in the radial direction. The concave portion is located between the positioning portion and the groove portion.

According to the above-described configuration, the groove portion recessed inward from the outer circumference of the rotor core is formed on the inter-pole portion side of the flux barrier, while the flux barrier has the concave portion on the inner side of the groove portion in the radial direction. Thus, a short circuit of magnetic flux between the magnetic poles is less likely to occur. Accordingly, the torque ripple can be reduced, and vibration can be suppressed.

### BRIEF DESCRIPTION OF THE DRAWINGS

FIG. 1 is a cross-sectional view illustrating a motor of a first embodiment.

FIG. 2 is a cross-sectional view illustrating a stator and a shell of the first embodiment.

FIG. 3 is a cross-sectional view illustrating a rotor of the first embodiment.

FIG. 4 is a cross-sectional view illustrating a part of the rotor of the first embodiment.

FIG. 5 is a cross-sectional view illustrating a part of a rotor core of the first embodiment.

FIG. 6 is an enlarged diagram illustrating a part including a groove portion of the rotor of the first embodiment.

FIG. 7 is an enlarged diagram illustrating a part including the groove portion of the rotor of the first embodiment.

FIG. 8 is a block diagram illustrating a drive device of the motor of the first embodiment.

FIG. 9 is a cross-sectional view illustrating a part of a rotor of Comparative Example.

FIG. 10 is an enlarged diagram illustrating a part including an inter-pole portion of the rotor of Comparative Example.

FIGS. 11(A) and 11(B) are diagrams illustrating simulation results of the flow of magnetic flux in a motor of Comparative Example.

FIG. 12 is a schematic diagram for explaining the flow of magnetic flux between magnetic poles in the motor of Comparative Example.

FIGS. 13(A) and 13(B) are diagrams illustrating simulation results of the flow of magnetic flux in the motor of the first embodiment.

FIG. 14 is a schematic diagram for explaining the flow of magnetic flux between magnetic poles in the motor of the first embodiment.

FIG. 15 is a graph illustrating analysis results of torque ripple in the first embodiment and Comparative Example.

FIG. 16 is a sectional view illustrating a compressor including the motor of the first embodiment.

FIG. 17 is a diagram illustrating a refrigeration cycle apparatus that includes the compressor illustrated in FIG. 16.

### DETAILED DESCRIPTION

### First Embodiment

### (Configuration of Motor)

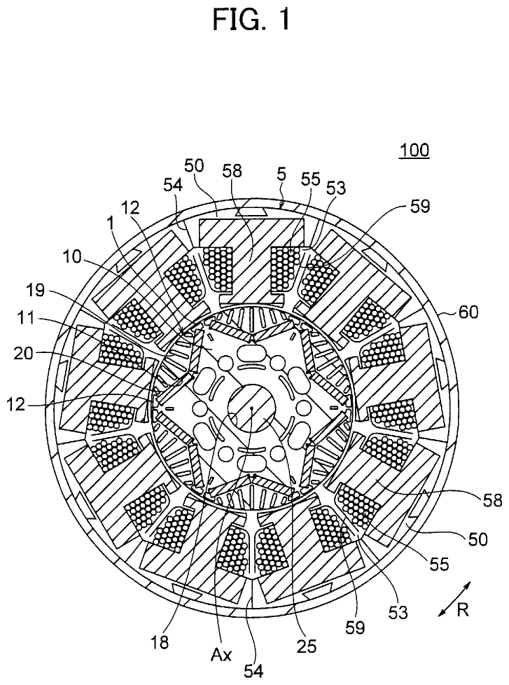

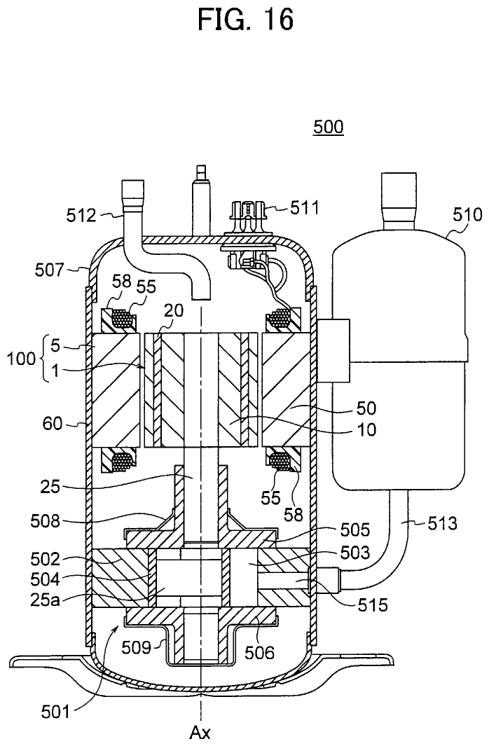

FIG. 1 is a cross-sectional view illustrating a motor 100 of a first embodiment. The motor 100 is a permanent magnet embedded motor that has permanent magnets 20 embedded in a rotor 1. The motor 100 is used in, for example, a compressor 500 (FIG. 16).

The motor 100 includes the rotor 1 that is rotatable and a stator 5 that is provided to surround the rotor 1. The stator 5 is fixed inside an annular shell 60. An air gap of, for example, 0.3 to 1.0 mm, is formed between the stator 5 and the rotor 1.

Hereinafter, the direction of an axis Ax, which is a rotation axis of the rotor 1, is referred to as an “axial direction”. The circumferential direction about the axis Ax (indicated by an arrow R in FIG. 1) is referred to as a “circumferential direction”. The radial direction about the axis Ax is referred to as a “radial direction”. The sectional view in a plane orthogonal to the axis Ax is referred to as a “cross-sectional view”. The sectional view in a plane parallel to the axis Ax is referred to as a “longitudinal-sectional view”.

### (Configuration of Stator)

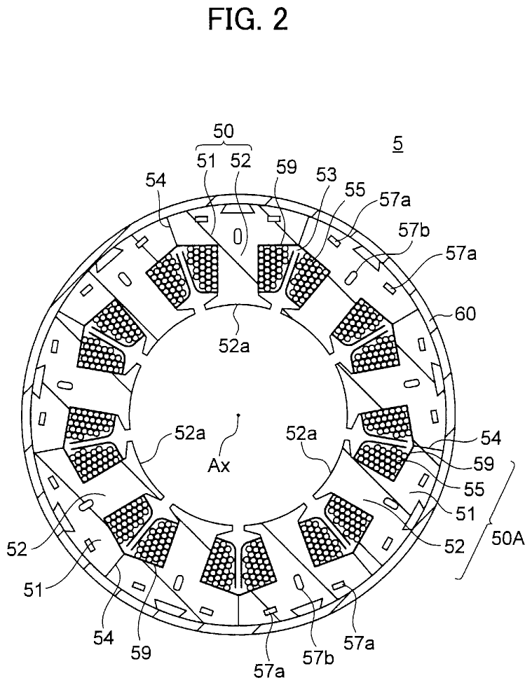

FIG. 2 is a cross-sectional view illustrating the stator 5 and the shell 60. The stator 5 includes a stator core 50, insulators 58 (FIG. 1) and insulating films 59, both of which are attached to the stator core 50, and windings 55 wound on the stator core 50 via the insulators 58 and the insulating films 59.

The stator core 50 is made of steel sheets which are stacked in the axial direction and integrally fixed together by crimping portions 57a. Each steel sheet is, for example, an electromagnetic steel sheet. The sheet thickness of the steel sheet is, for example, 0.1 to 0.7 mm, and 0.35 mm in this example.

The stator core 50 has a yoke 51 having an annular shape about the axis Ax and a plurality of teeth 52 extending inward in the radial direction from the yoke 51. An outer circumferential surface of the yoke 51 is fixed to an inner circumferential surface of the shell 60.

The teeth 52 are formed at equal intervals in the circumferential direction. The number of teeth 52 is nine in this example, but only needs to be two or more. The tooth 52 has a tooth tip portion 52a at its inner end in the radial direction, and the tooth tip portion 52a faces the rotor 1. The tooth tip portion 52a has a wider width than the other portions of the tooth 52. A slot 53 that houses the winding 55 is formed between adjacent teeth 52.

The insulating film 59 is attached to an inner surface of the slot 53. The insulating film 59 is composed of, for example, a resin such as polyethylene terephthalate (PET) or the like. The insulator 58 (FIG. 1) is attached to each of both ends of the tooth 52 in the axial direction. The insulator 58 is composed of, for example, a resin such as polybutylene terephthalate (PBT).

The insulator 58 and the insulating film 59 constitute an insulating portion that electrically insulates the stator core 50 and the winding 55 from each other. The winding 55 is wound around the tooth 52 via the insulator 58 and the insulating film 59.

The winding 55 is composed of, for example, a magnet wire. The wire diameter of the winding 55 is, for example, 1.0 mm. The winding 55 is wound around each tooth 52, for example, 80 turns, in concentrated winding. The number of turns and wire diameter of the winding 55 are determined depending on the required specifications (the number of revolutions, a torque, or the like) of the motor 100, the supply voltage, and the sectional area of the slot 53.

The crimping portions 57a are formed on the yoke 51 for integrally fixing the steel sheets constituting the stator core 50. The crimping portions 57a are formed, for example, on both sides in the circumferential direction with respect to a straight line in the radial direction that passes through the center of the tooth 52.

Fitting holes 57b are formed on the yoke 51, and protrusions formed on the insulators 58 are fitted into the fitting holes 57b. Each fitting hole 57b is formed on the inner side of the crimping portion 57a in the radial direction and on the straight line in the radial direction that passes through the center of the tooth 52. Incidentally, the number and arrangement of the crimping portions 57a and the fitting holes 57b are not limited.

The stator core 50 has a configuration in which a plurality of split cores 50A each including one tooth 52 are connected together in the circumferential direction. The number of split cores 50A is, for example, nine. These split cores 50A are joined to each other at joint surfaces 54 formed in the yoke 51. The joining is performed by, for example, welding, but is not limited to welding.

The stator 5 is fixed inside the annular shell 60. More specifically, the stator core 50 of the stator 5 is fitted into the shell 60 by shrink-fitting or press-fitting. The shell 60 is a part of a sealed container 507 of the compressor 500 (FIG. 16).

### (Configuration of Rotor)

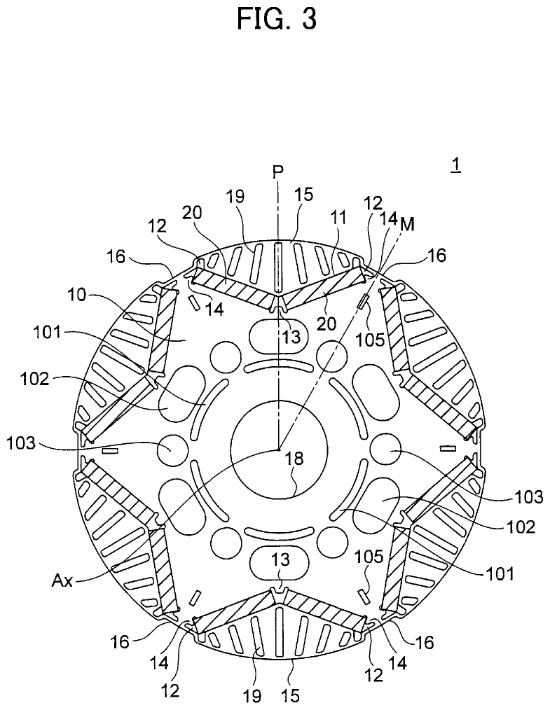

FIG. 3 is a cross-sectional view illustrating the rotor 1. The rotor 1 has a cylindrical rotor core 10 and the permanent magnets 20 attached to the rotor core 10. A shaft 25 (FIG. 1) is fixed to the center of the rotor core 10. The shaft 25 is, for example, a shaft of the compressor 500 (FIG. 16).

The rotor core 10 is made of steel sheets which are stacked in the axial direction and integrally fixed together by crimping portions 105. Each steel sheet is, for example, an electromagnetic steel sheet. The sheet thickness of the steel sheet is, for example, 0.1 to 0.7 mm, and 0.35 mm in this example. A shaft hole 18 is formed at the center of the rotor core 10 in the radial direction, and the above-described shaft 25 is fixed to the shaft hole 18.

A plurality of magnet insertion holes 11 into which the permanent magnets 20 are inserted are formed along an outer circumferential surface of the rotor core 10. Each magnet insertion hole 11 is formed from one end to the other end of the rotor core 10 in the axial direction. Each magnet insertion hole 11 corresponds to one magnetic pole (denoted by reference character P). The number of magnet insertion holes 11 is six in this example, and therefore the number of magnetic poles is six. In this regard, the number of magnetic poles is not limited to six, but only needs to be two or more.

The magnet insertion hole 11 is formed in a V shape that has its center in the circumferential direction protruding toward the axis Ax. Two permanent magnets 20 are disposed in each magnet insertion hole 11. The two permanent magnets 20 disposed in the same magnet insertion hole 11 are arranged so that the magnetic poles of the same polarity face outward in the radial direction.

The permanent magnet 20 is a flat-plate shaped member elongated in the axial direction and has a width in the circumferential direction of the rotor core 10 and a thickness in the radial direction of the rotor core 10. The thickness of the permanent magnet 20 is, for example, 2 mm. The permanent magnet 20 is composed of a rare earth magnet that contains, for example, neodymium (Nd), iron (Fe), and boron (B). The permanent magnet 20 is magnetized in its thickness direction.

The above-described rare earth magnet has the characteristics such that its coercive force decreases as the temperature increases. The rate of decrease in the coercive force is −0.5 to −0.6%/K. In order to prevent demagnetization of the rare earth magnet when the maximum load expected in the compressor occurs, a coercive force of 1100 to 1500 A/m is required. Further, in order to secure this coercive force at the ambient temperature of 150° C., the coercive force at normal temperature (20° C.) needs to be in a range of 1800 to 2300 A/m.

Thus, dysprosium (Dy) may be added to the rare earth magnet. The coercive force of the rare earth magnet at normal temperature is 1800 A/m when Dy is not added, and is 2300 A/m when 2% by weight of Dy is added. However, the addition of Dy causes an increase in the manufacturing cost and leads to reduction in the residual magnetic flux density. Therefore, it is desirable to add as little Dy as possible or not to add Dy.

The center of a magnetic pole P in the rotor 1, i.e., the center of the magnet insertion hole 11 in the circumferential direction, is defined as a pole center. A straight line in the radial direction that passes through the pole center is referred to as a pole center line. An inter-pole portion M is defined between the magnet insertion holes 11 that are adjacent to each other in the circumferential direction, i.e., between the magnetic poles.

The shape of the magnet insertion hole 11 is not limited to the V shape described above, but the magnet insertion hole 11 may be formed linearly. One permanent magnet 20 may be disposed in each magnet insertion hole 11, or two or more permanent magnets 20 may be disposed in each magnet insertion hole 11.

In the rotor core 10, holes 101 and 102 are formed on the inner side of the magnet insertion holes 11 in the radial direction. The holes 101 are formed in an arc shape along the inner circumference of the shaft hole 18. The holes 102 are formed between the holes 101 and the magnet insertion holes 11 in the radial direction. Holes 103 are formed on the inner side of the inter-pole portion M in the radial direction.

Each of the holes 101, 102, and 103 is formed from one end to the other end of the rotor core 10 in the axial direction and serves as a passage of a refrigerant in the compressor (FIG. 16). In this regard, the number and arrangement of the holes in the rotor core 10 may be changed as appropriate.

The crimping portions 105 for integrally fixing the steel sheets constituting the rotor core 10 are formed on the inner side of the inter-pole portions M in the radial direction. Each crimping portion 105 is formed, for example, between the magnet insertion holes 11 adjacent to each other in the circumferential direction. In this regard, the number and arrangement of the crimping portions 105 may be changed as appropriate.

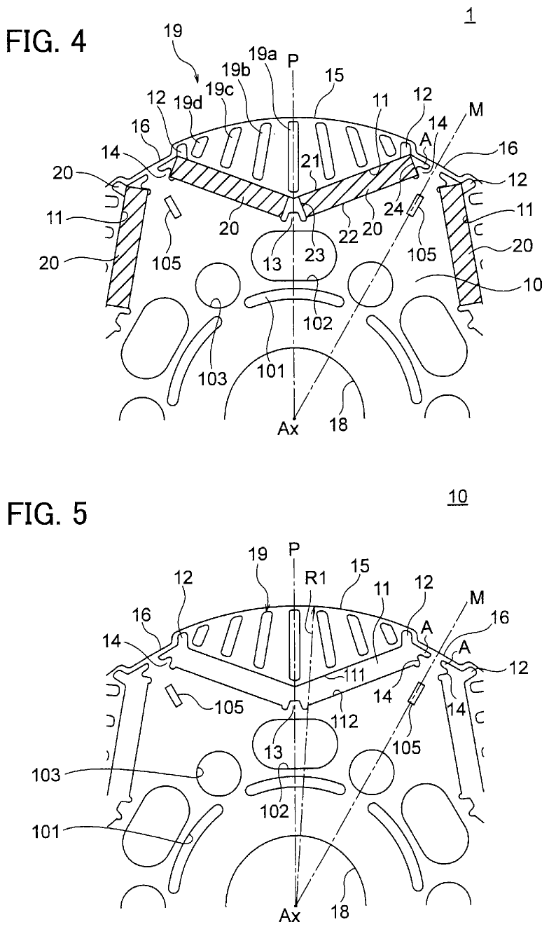

FIG. 4 is an enlarged diagram illustrating a part of the rotor 1. A group of slits 19 are formed on an outer circumference 15 side of the magnet insertion hole 11. The group of slits 19 include slits 19a, 19b, 19c, and 19d that are formed symmetrically in the circumferential direction with respect to the pole center line.

More specifically, the group of slits 19 include the slit 19a disposed on the pole center line, the slits 19b disposed on both sides of the slits 19a in the circumferential direction, the slits 19c disposed on both sides of the slits 19b in the circumferential direction, and the slits 19d disposed on both sides of the slits 19c in the circumferential direction.

The slits 19a to 19d are arranged at equal intervals in the circumferential direction, and are all elongated in the radial direction. The slit 19a is the longest, the slit 19b is the second longest, the slit 19c is the third longest, and the slit 19d is the shortest.

The group of slits 19 are provided to smooth the distribution of magnetic flux from the permanent magnets 20 toward the stator 5. Smoothing the distribution of the magnetic flux reduces the harmonics of the voltage (induced voltage) induced in the windings 55 by magnetic field of the permanent magnets 20 during rotation of the rotor 1. In this regard, the number and arrangement of the slits constituting the group of slits 19 are not limited to the example described herein. It is also possible to employ a configuration in which the group of slits 19 are not provided in the rotor core 10.

Two permanent magnets 20 are disposed in each magnet insertion hole 11 as described above. Each permanent magnet 20 has a magnetic pole face 21 on the outer side in the radial direction, a magnetic pole face 22 on the inner side in the radial direction, an end face 23 on the inner side in the circumferential direction, and an end face 24 on the outer side in the circumferential direction.

FIG. 5 is an enlarged diagram illustrating a part of the rotor core 10. The magnet insertion hole 11 has an outer end edge 111 on the outer side in the radial direction and an inner end edge 112 on the inner side in the radial direction. The outer end edge 111 faces the magnetic pole face 21 of the permanent magnet 20 (FIG. 4), while the inner end edge 112 faces the magnetic pole face 22 of the permanent magnet 20 (FIG. 4). Both the outer end edge 111 and the inner end edge 112 extend in a V shape.

A first convex portion 13 and second convex portions 14 are formed inside the magnet insertion hole 11 for positioning the permanent magnets 20. The first convex portion 13 protrudes from the inner end edge 112 at the center of the magnet insertion hole 11 in the circumferential direction and faces the end faces 23 of the permanent magnets 20 (FIG. 4).

The second convex portion 14 protrudes from the inner end edge 112 at the end of the magnet insertion hole 11 in the circumferential direction and faces the end face 24 of the permanent magnet 20 (FIG. 4). The first convex portion 13 and the second convex portions 14 determine the positions of the permanent magnets 20 in the circumferential direction so that the permanent magnets 20 do not move within the magnet insertion hole 11.

A flux barrier 12 is formed on each of both ends of the magnet insertion hole 11 in the circumferential direction. The flux barrier 12 is formed at the inter-pole portion M side of the magnet insertion hole 11. A part of the flux barrier 12 is located on the outer circumference 15 side of the magnetic pole face 21 of the permanent magnet 20 (FIG. 4).

That is, the flux barrier 12 suppresses the magnetic flux exiting from the magnetic pole face 21 of the permanent magnet 20 from flowing to the inter-pole portion M side, or suppresses the magnetic flux flowing through the inter-pole portion M from flowing into the magnetic pole face 21.

A portion of the outer circumference 15 of the rotor core 10 that is located on the outer side of the magnet insertion hole 11 in the radial direction has an arc shape having a radius R1 about the axis Ax. This arc portion extends in the circumferential direction to both sides of the pole center.

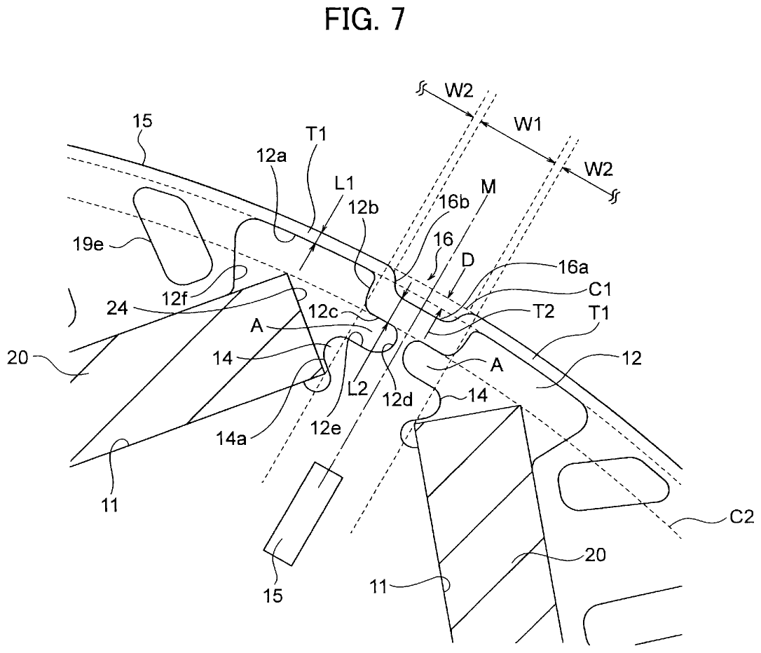

Meanwhile, a groove portion 16 is formed at the inter-pole portion M of the outer circumference 15 of the rotor core 10. The groove portion 16 is recessed inward in the radial direction with respect to a circle having the radius R1 about the axis Ax (the virtual circle C1 illustrated in FIG. 7). The groove portion 16 is formed between the flux barriers 12 of the magnet insertion holes 11 adjacent to each other in the circumferential direction.

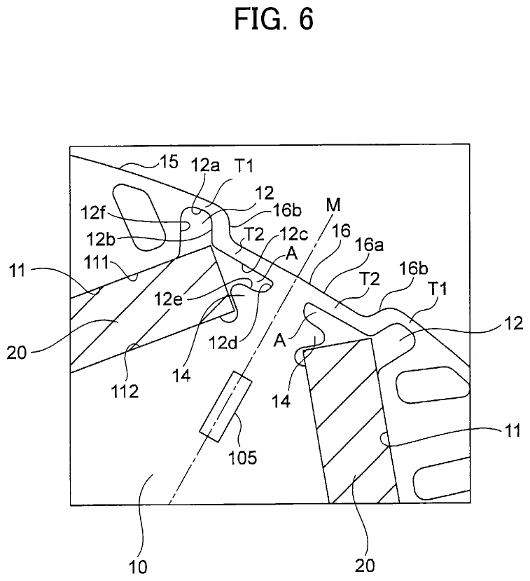

FIG. 6 is an enlarged diagram illustrating a part including the groove portion 16 of the rotor core 10. The groove portion 16 has a bottom portion 16a extending in the circumferential direction and side portions 16b on both sides of the bottom portion 16a in the circumferential direction. The side portions 16b are inclined such that the width of the groove portion 16 in the circumferential direction increases outward in the radial direction.

The flux barrier 12 has a first side 12a extending in the circumferential direction along the outer circumference 15, a second side 12b extending inward in the radial direction from the end of the first side 12a on the inter-pole portion M side, and a third side 12c extending from the inner end in the radial direction of the second side 12b toward the inter-pole M side in the circumferential direction.

The flux barrier 12 also has a fourth side 12d extending inward in the radial direction from the end of the third side 12c on the inter-pole portion M side, and a fifth side 12e extending from the inner end in the radial direction of the fourth side 12d to the side opposite to the inter-pole portion M in the circumferential direction. The fifth side 12e faces the third side 12c in the radial direction. The fifth side 12e is a part of the second convex portion 14.

A concave portion A is formed by a region enclosed by the third side 12c, the fourth side 12d, and the fifth side 12e. The concave portion A is located on the inner side of the groove portion 16 in the radial direction.

The flux barrier 12 further has a sixth side 12f extending inward in the radial direction from the end of the first side 12a on the side opposite to the inter-pole portion M. The sixth side 12f faces the second side 12b in the circumferential direction.

A first thin-walled portion T1 is formed between the first side 12a of the flux barrier 12 and the outer circumference 15 of the rotor core 10. A second thin-walled portion T2 is formed between the third side 12c of the flux barrier 12 and the bottom portion 16a of the groove portion 16. Both the thin-walled portions T1 and T2 extend in the circumferential direction.

FIG. 7 is a schematic diagram for explaining the dimensions of portions around the groove portion 16. A width L1 of the first thin-walled portion T1 in the radial direction is a distance between the first side 12a of the flux barrier 12 and the outer circumference 15 of the rotor core 10. A width L2 of the second thin-walled portion T2 in the radial direction is a distance between the third side 12c of the flux barrier 12 and the bottom portion 16a of the groove portion 16.

The width L1 of the first thin-walled portion T1 is narrower than the sheet thickness of each of the steel sheets constituting the rotor core 10. Meanwhile, the width L2 of the second thin-walled portion T2 in the radial direction is wider than the width L1 of the first thin-walled portion T1.

The virtual circle having the radius R1 (FIG. 5) and defining the outer circumference 15 of the rotor core 10 is denoted by C1. A depth D of the groove portion 16 is a distance from the virtual circle C1 to the bottom portion 16a in the radial direction. The depth D of the groove portion 16 is smaller than the width L1 of the first thin-walled portion T1 in the radial direction.

The groove portion 16 is provided at a position that does not overlap the permanent magnet 20 in the radial direction. That is, when ranges are expressed as an angular range about the axis Ax, an angular range W1 in which the groove portion 16 is formed does not overlap an angular range W2 in which the permanent magnet 20 is provided.

The groove portion 16 is formed on the outer side in the radial direction with respect to the region where the permanent magnet 20 is provided. That is, when a virtual circle C2 is defined as a circle about the axis Ax which passes through outermost points of the permanent magnets 20 in the radial direction, the groove portion 16 is formed outside the virtual circle C2.

### (Drive Device)

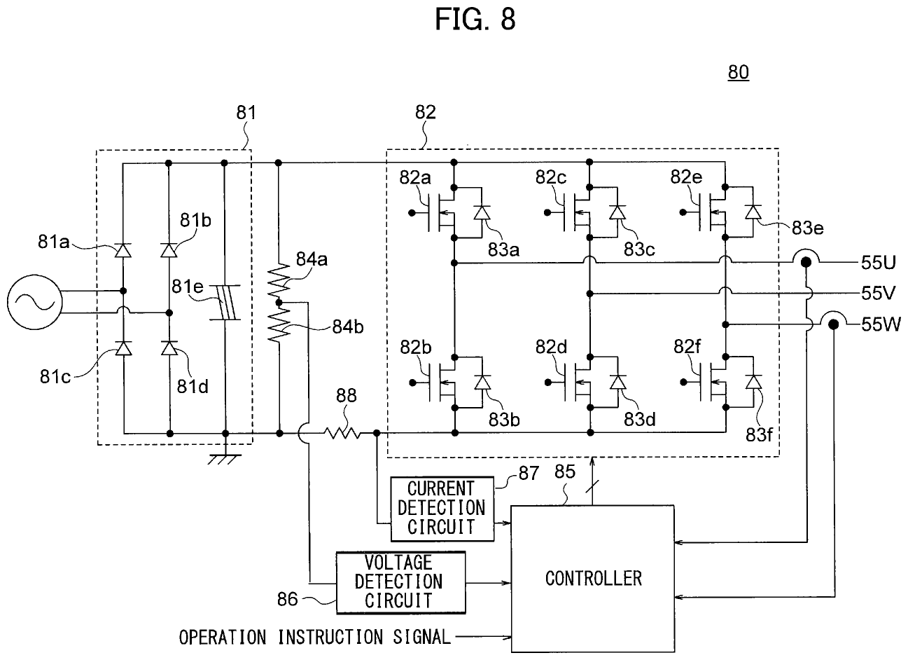

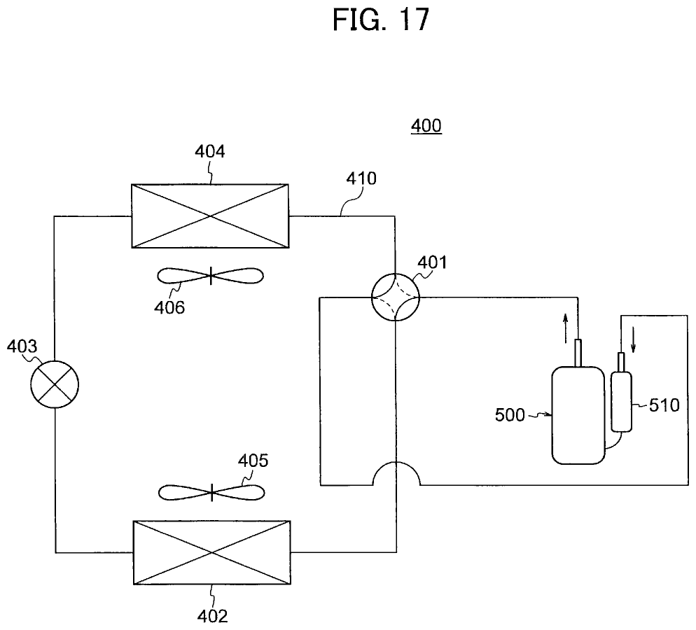

FIG. 8 is a block diagram illustrating a drive device 80 that drives the motor 100. The drive device 80 is a part of a refrigeration cycle apparatus 400 (FIG. 17). As illustrated in FIG. 8, the drive device 80 includes a rectifier circuit 81 that converts an AC voltage supplied from a commercial AC power source into a DC voltage, an inverter circuit 82 that converts the DC voltage output from the rectifier circuit 81 into an AC voltage and supplies the AC voltage to the motor 100, a controller 85 that drives the inverter circuit 82, a voltage detection circuit 86, and a current detection circuit 87.

The rectifier circuit 81 has bridge diodes 81a, 81b, 81c and 81d and a smooth capacitor 81e. Voltage divider resistors 84a and 84b are connected in series between bus lines of the rectifier circuit 81. The voltage detection circuit 86 detects an electrical signal converted to a low voltage by the voltage divider resistors 84a and 84b. A shunt resistor 88 is connected to the bus line of the rectifier circuit 81. The current detection circuit 87 is connected to the shunt resistor 88 and detects a current value of the current input to the inverter circuit 82.

The inverter circuit 82 is a three-phase bridge inverter circuit. The inverter circuit 82 has U-phase switching elements 82a and 82b, V-phase switching elements 82c and 82d, and W-phase switching elements 82e and 82f. The switching elements 82a, 82c and 82e are upper arms, while the switching elements 82b, 82d and 82f are lower arms.

The switching elements 82a and 82b are connected to a U-phase winding 55U of the motor 100. The switching elements 82c and 82d are connected to a V-phase winding 55V. The switching elements 82e and 82f are connected to a W-phase winding 55W. Reflux rectifier elements 83a to 83f are connected in parallel with the switching elements 82a to 82f, respectively.

The AC power output from the inverter circuit 82 is supplied to the windings 55U, 55V, and 55W of the respective phases of the motor 100 to generate a rotating magnetic field, thereby rotating the rotor 1. The controller 85 detects position information of the rotor 1 based on current values of the current flowing through the windings 55U and 55W.

The controller 85 outputs a PWM signal to the inverter circuit 82 based on an operation instruction signal from a remote operation device (remote controller), detection signals from the voltage detection circuit 86 and the current detection circuit 87, and the position information of the rotor 1.

### (Function)

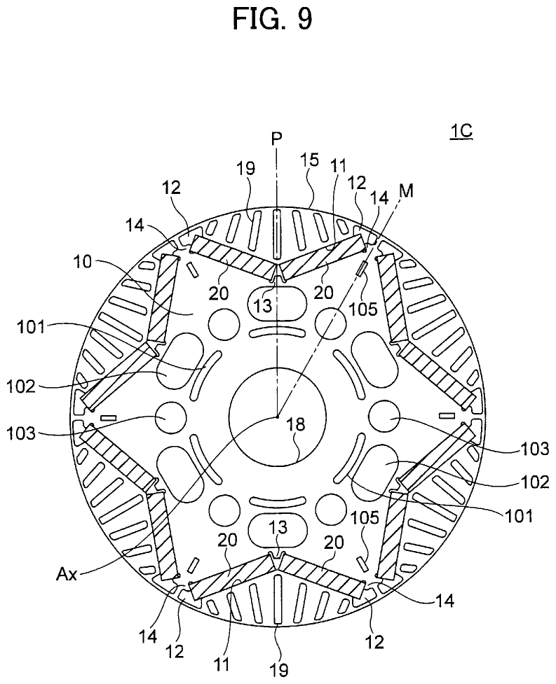

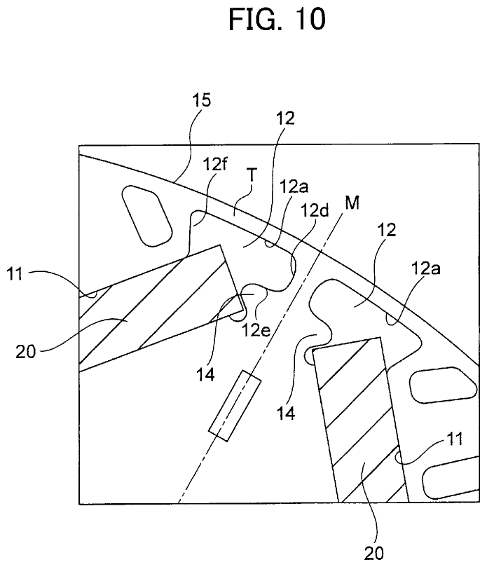

Next, the function of the first embodiment will be described. First, a rotor 1C of Comparative Example for comparison with the first embodiment will be described. FIG. 9 is a cross-sectional view illustrating the rotor 1C of Comparative Example. FIG. 10 is an enlarged diagram illustrating a part including an inter-pole portion M of the rotor 1C.

As illustrated in FIG. 9, the rotor 1C of Comparative Example has a circular outer circumference 15 having no groove portion 16 (FIG. 6) at the inter-pole portion M. As illustrated in FIG. 10, the flux barrier 12 of the rotor 1C of Comparative Example has no second side 12b and no third side 12c (FIG. 6).

A thin-walled portion T extending in the circumferential direction is formed between the outer circumference 15 of the rotor core 10 and the first side 12a of the flux barrier 12 in Comparative Example. The rotor 1C of Comparative Example has the same configuration as the rotor 1 of the first embodiment in other respects.

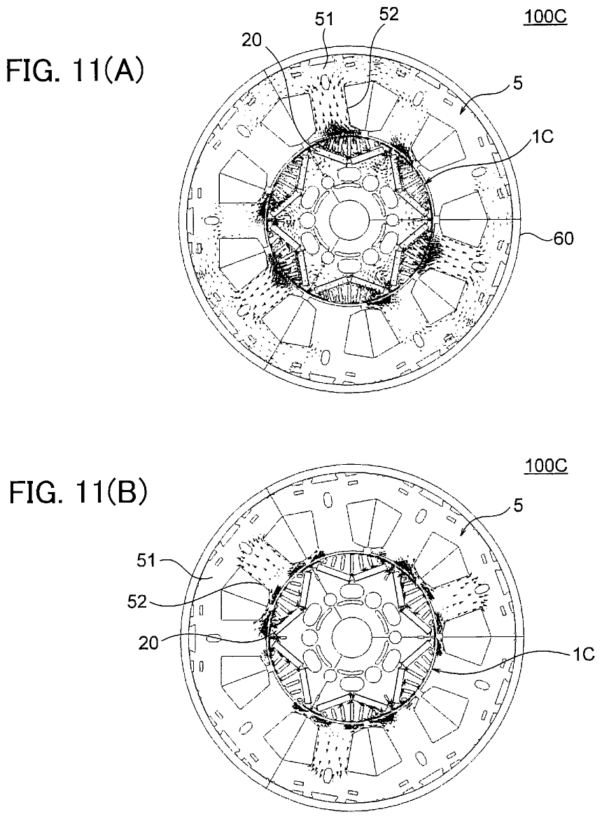

FIGS. 11(A) and 11(B) are diagrams illustrating simulation results of the flow of magnetic flux in a motor 100C having the rotor 1C of Comparative Example. FIG. 11(A) illustrates the flow of magnetic flux when no field-weakening control is performed, i.e., during a normal operation. FIG. 11(B) illustrates the flow of magnetic flux when field-weakening control is performed, i.e., during a field-weakening operation.

As illustrated in FIG. 11(A), the magnetic flux exiting from one permanent magnet 20 of the rotor 1C flows to the tooth 52 of the stator 5, then flows from the tooth 52 to the yoke 51, and flows to the permanent magnet 20 of the adjacent magnetic pole through the adjacent tooth 52.

When the magnetic flux flows through the teeth 52 of the stator 5, an induced voltage is generated in the windings 55. The induced voltage increases in proportion to the rotational speed of the rotor 1C and reaches the maximum output voltage of the inverter circuit 82 at a certain number of revolutions.

When the induced voltage reaches the maximum output voltage of the inverter circuit 82, the output voltage of the inverter circuit 82 cannot be made higher than this, and thus the field-weakening control is started. In the field-weakening control, a d-axis phase current, i.e., a field-weakening current, is applied to the winding 55. Since the weakening current is applied in addition to the current for generating a motor torque, the current value of the current flowing in the winding 55 increases during the field-weakening operation.

Further, the field-weakening current generates magnetic flux in a direction to cancel the magnetic flux of the permanent magnet 20, and thus the path of the magnetic flux exiting from the permanent magnet 20 changes. In other words, as illustrated in FIG. 11(B), the magnetic flux exiting from the permanent magnet 20 easily flows to the permanent magnet 20 of the adjacent magnetic pole through the tooth tip portion 52a of the tooth 52. That is, the magnetic flux flowing in a path passing through the tooth 52 and the yoke 51 of the stator 5 decreases, and the short circuit of the magnetic flux between the magnetic poles of the rotor 1C increases.

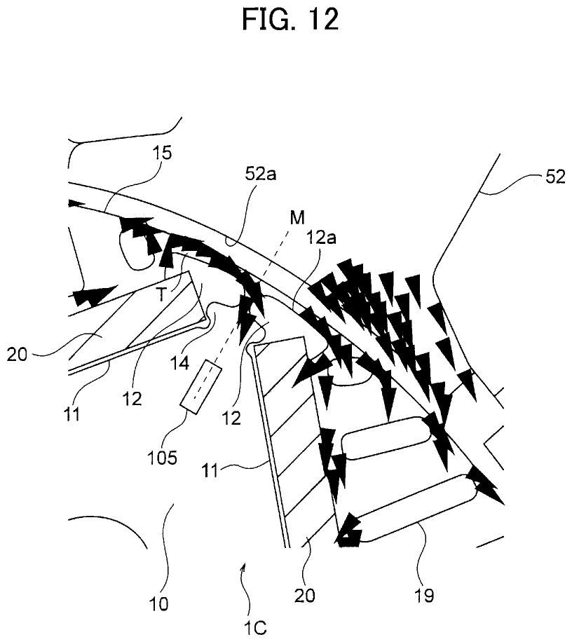

FIG. 12 is a schematic diagram for explaining the flow of magnetic flux between the magnetic poles of the rotor 1C during the field-weakening operation. The magnetic flux exiting from the permanent magnet 20 flows through the thin-walled portion T between the outer circumference 15 of the rotor core 10 and the flux barrier 12, and then flows to the permanent magnet 20 of the adjacent magnetic pole through the tooth tip portion 52a of the tooth 52.

Such short circuit of the magnetic flux between the magnetic poles of the rotor 1C increases the harmonics of the induced voltage. The magnitude of the torque ripple is proportional to the product of the current flowing through the winding 55 and the harmonics of the induced voltage. Thus, in the motor 100C of Comparative Example, torque ripple increases during the field-weakening operation.

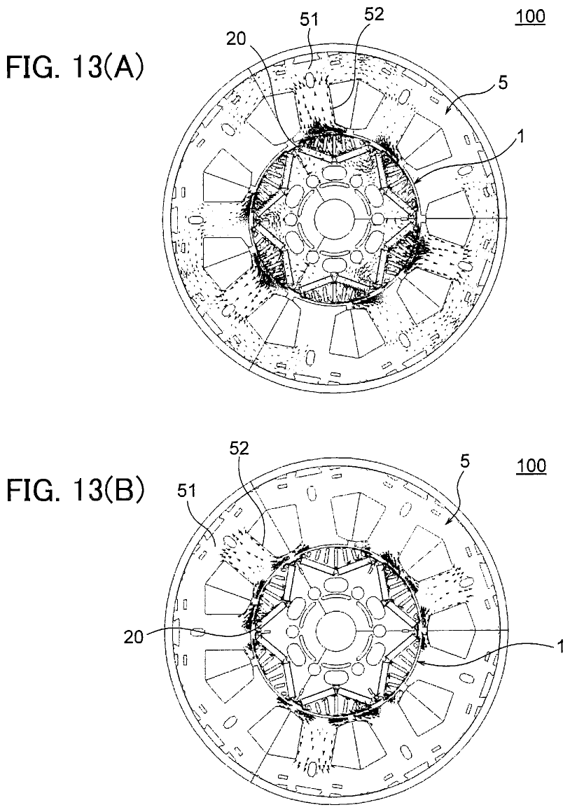

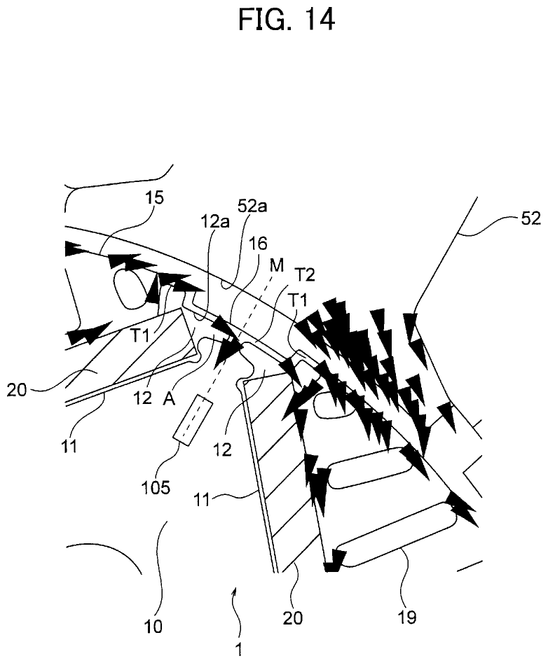

FIGS. 13(A) and 13(B) are diagrams illustrating simulation results of the flow of magnetic flux in the motor 100 of the first embodiment. FIG. 13(A) illustrates the flow of magnetic flux during a normal operation, while FIG. 13(B) illustrates the flow of magnetic flux during a field-weakening operation. FIG. 14 is a schematic diagram for explaining the flow of magnetic flux between the magnetic poles of the rotor 1 during the field-weakening operation.

As illustrated in FIG. 13(A), the flow of magnetic flux in the rotor 1 and the stator 5 during the normal operation is the same as that in Comparative Example illustrate in FIG. 11(A).

During the field-weakening operation, as illustrated in FIG. 13(B), the magnetic flux exiting from the permanent magnet 20 is about to flow to the permanent magnet 20 of the adjacent magnetic pole through the tooth tip portion 52a of the tooth 52.

However, as illustrated in FIG. 14, the groove portion 16 is formed at the inter-pole portion M of the outer circumference 15 of the rotor core 10, and the concave portion A of the flux barrier 12 is formed on the inner side of the groove portion 16 in the radial direction.

Thus, the magnetic flux exiting from the magnetic pole face 21 of the permanent magnet 20 directed toward the inter-pole portion M passes through the first thin-walled portion T1 between the flux barrier 12 and the outer circumference 15 and further passes through the second thin-walled portion T2 between the groove portion 16 and the concave portion A of the flux barrier 12.

The second thin-walled portion T2 is located on the inner side relative to the first thin-walled portion T1 in the radial direction, and thus the magnetic flux flows in the direction away from the tooth tip portion 52a of the tooth 52. As a result, the magnetic flux flowing to the permanent magnet 20 of the adjacent magnetic pole through the tooth tip portion 52a of the tooth 52 is reduced.

Thus, the short circuit of the magnetic flux between the magnetic poles of the rotor 1 can be suppressed, and the harmonics of the induced voltage can be reduced. As a result, torque ripple can be reduced, and vibration of the motor 100 can be suppressed.

In FIG. 7, if the depth D of the groove portion 16 is set to be smaller than or equal to the width L1 of the first thin-walled portion T1, part of the magnetic flux flowing through the first thin-walled portion T1 flows to the second thin-walled portion T2 in the circumferential direction. However, in the first embodiment, the depth D of the groove portion 16 is larger than the width L1 of the first thin-walled portion T1, and thus the magnetic flux flowing from the first thin-walled portion T1 to the second thin-walled portion T2 is more likely to flow in the direction away from the tooth tip portion 52a of the tooth 52. Therefore, it is possible to enhance the effect of suppressing short circuit of the magnetic flux between the magnetic poles of the rotor 1 through the tooth tip portion 52a of the tooth 52.

The width L1 of the first thin-walled portion T1 is the smallest among the portions around the flux barrier 12. Thus, the effect of suppressing short circuit of the magnetic flux between the magnetic poles of the rotor 1 can be obtained in both the normal operation and the field-weakening operation.

In particular, since the width L1 of the first thin-walled portion T1 is narrower than the sheet thickness of the steel sheet, the permeance in the radial direction can be made smaller as compared with the permeance in the axial direction. As a result, the magnetic flux flowing to the tooth tip portion 52a of the tooth 52 can be reduced.

The width L2 of the second thin-walled portion T2 between the groove portion 16 and the concave portion A is wider than the width L1 of the first thin-walled portion T1. The magnetic flux passing through the first thin-walled portion T1 is directed to the tooth tip portion 52a of the tooth 52 or the second thin-walled portion T2. By increasing the width of the second thin-walled portion T2 to make the permeance of the second thin-walled portion T2 relatively large, the magnetic flux passing through the first thin-walled portion T1 is likely to be directed to the second thin-walled portion T2. Thus, the effect of suppressing short circuit of the magnetic flux between the magnetic poles of the rotor 1 can be further enhanced.

The groove portion 16 is provided at the position that does not overlap the permanent magnet 20 in the radial direction as described above. In other words, the angular range W1 in which the groove portion 16 extends does not overlap the angular range W2 in which the permanent magnet 20 is provided.

Thus, the flow of magnetic flux during the normal operation, i.e., the flow of magnetic flux flowing through a path passing from the permanent magnet 20 through the tooth 52 and yoke 51 of the stator 5 is not obstructed by the groove portion 16. Consequently, a reduction in the output torque of the motor 100 can be suppressed.

The groove portion 16 is formed on the outer side of the virtual circle C2 that passes through the outermost points of the permanent magnets 20 in the radial direction, and thus short circuit of the magnetic flux between the magnetic pole faces 21 and 22 of the same permanent magnet 20 can be suppressed.

That is, the short circuit of the magnetic flux may occur not only between adjacent magnetic poles, but also between the magnetic pole faces 21 and 22 of the same permanent magnet 20. In this case, if the magnetic pole face 21 is the S pole, the magnetic flux exiting from the magnetic pole face 21 passes through the outside of the virtual circle C2 and again enters an area inside the virtual circle C2 to reach the magnetic pole face 22.

By forming the groove portion 16 outside the virtual circle C2, the path for such a short-circuit magnetic flux can be made narrower. Thus, the short circuit of the magnetic flux between the magnetic pole faces 21 and 22 of the permanent magnet 20 can be suppressed, and a reduction in the output torque can be suppressed.

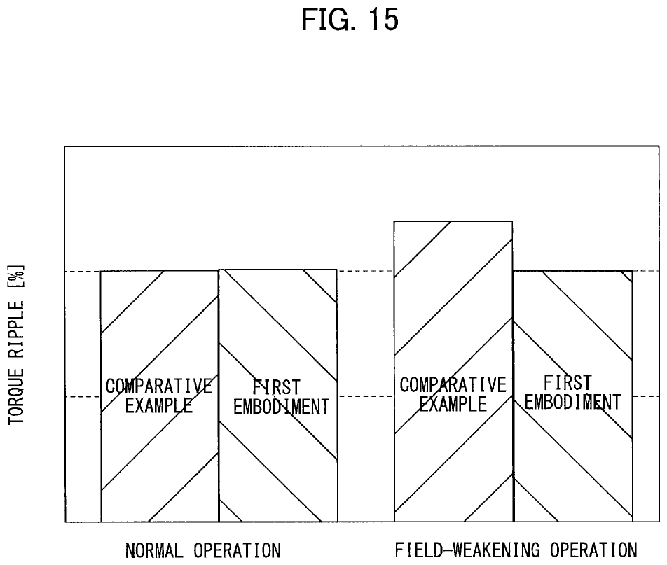

FIG. 15 is a graph illustrating analytical values of torque ripples in the motors of the first embodiment and Comparative Example. The vertical axis represents the torque ripple as a relative value. The torque ripple during a normal operation in the first embodiment is equivalent to that in Comparative Example.

In contrast, during a field-weakening operation, the torque ripple is found to increase in Comparative Example, while an increase in the torque ripple is suppressed in the first embodiment. This is because the short circuit of the magnetic flux between the magnetic poles of the rotor 1 is suppressed by providing the groove portion 16 at the inter-pole portion M of the rotor core 10 and also providing the concave portion A in the flux barrier 12 on the inner side of the groove portion 16 in the radial direction in the first embodiment.

### (Configuration of Compressor)

FIG. 16 is a longitudinal-sectional view illustrating the compressor 500 including the motor 100 of the first embodiment. The compressor 500 is a rotary compressor and is used, for example, in the refrigeration cycle apparatus 400 (FIG. 17).

The compressor 500 includes a compression mechanism 501, the motor 100 that drives the compression mechanism 501, the shaft 25 that connects the compression mechanism 501 and the motor 100, and the sealed container 507 that houses these components. In this example, the axial direction of the shaft 25 is the vertical direction, and the motor 100 is disposed above the compression mechanism 501.

The sealed container 507 is a container made of a steel sheet and includes the cylindrical shell 60, a container top covering the upper side of the shell 60, and a container bottom covering the lower side of the shell 60. The stator 5 of the motor 100 is incorporated inside the shell 60 by shrink-fitting, press-fitting, welding, or the like.

The container top of the sealed container 507 is provided with a discharge pipe 512 for discharging a refrigerant to the outside and terminals 511 for supplying electric power to the motor 100. An accumulator 510 that stores a refrigerant gas is attached to the outside of the sealed container 507. At the container bottom of the sealed container 507, a refrigerant oil is retained to lubricate bearing portions of the compression mechanism 501.

The compression mechanism 501 includes a cylinder 502 having a cylinder chamber 503, a rolling piston 504 fixed to the shaft 25, a vane dividing the inside of the cylinder chamber 503 into a suction side and a compression side, and an upper frame 505 and a lower frame 506 which close both ends of the cylinder chamber 503 in the axial direction.

Both the upper frame 505 and lower frame 506 have bearing portions rotatably supporting the shaft 25. An upper discharge muffler 508 and a lower discharge muffler 509 are attached to the upper frame 505 and the lower frame 506, respectively. The upper frame 505 has a discharge outlet communicating with a discharge port (described later) of the cylinder 502. The discharge outlet is provided with a discharge valve.

The cylinder 502 is provided with the cylinder chamber 503 having a cylindrical shape about the axis Ax. An eccentric shaft portion 25a of the shaft 25 is located inside the cylinder chamber 503. The eccentric shaft portion 25a has the center that is eccentric relative to the axis Ax. The rolling piston 504 is fitted to the outer circumference of the eccentric shaft portion 25a. When the motor 100 rotates, the eccentric shaft portion 25a and the rolling piston 504 rotate eccentrically in the cylinder chamber 503.

The cylinder 502 has a suction port 515 through which the refrigerant gas is sucked into the cylinder chamber 503 and a discharge port from which the refrigerant compressed by the cylinder chamber 503 is discharged. A suction pipe 513 of the sealed container 507 is connected to the suction port 515, and the refrigerant gas is supplied from the accumulator 510 to the cylinder chamber 503 via the suction pipe 513.

The compressor 500 is supplied with a mixture of a low-pressure refrigerant gas and a liquid refrigerant from a refrigerant circuit of the refrigeration cycle apparatus 400 (FIG. 17). If the liquid refrigerant flows into and is compressed by the compression mechanism 501, it may cause the failure of the compression mechanism 501. Thus, the accumulator 510 separates the refrigerant into the liquid refrigerant and the refrigerant gas and supplies only the refrigerant gas to the compression mechanism 501.

The operation of the compressor 500 is as follows. When current is applied to the windings 55 of the stator 5 via the terminals 511, the attraction force or repulsive force is generated between the stator 5 and the rotor 1 by the rotating magnetic field generated by the current and the magnetic field of the permanent magnets 20 of the rotor 1, causing the rotor 1 to rotate. This causes the shaft 25 fixed to the rotor 1 to rotate.

The low-pressure refrigerant gas from the accumulator 510 is sucked into the cylinder chamber 503 of the cylinder 502 via the suction port 515. In the cylinder chamber 503, the eccentric shaft portion 25a of the shaft 25 and the rolling piston 504 attached to the shaft portion 25a rotate eccentrically to compress the refrigerant in the cylinder chamber 503.

The refrigerant compressed in the cylinder chamber 503 is discharged into the sealed container 507 through the discharge port, the discharge outlet of the upper frame 505, and the discharge mufflers 508 and 509. The refrigerant discharged into the sealed container 507 rises inside the sealed container 507 through the holes 101, 102, and 103 (FIG. 3) of the rotor core 10 and the like, is discharged trough the discharge pipe 512, and is sent out to the refrigerant circuit in the refrigeration cycle apparatus 400 (FIG. 17).

In the compressor 500, for example, a refrigerant containing a substance having the property of causing a disproportionation reaction can be used. The substance having the property of causing a disproportionation reaction is, for example, an ethylene-based hydrofluorocarbon. Specific examples of the substance having the property of causing a disproportionation reaction include 1,1,2-trifluoroethylene, and 1,2-difluoroethylene.

For example, the above refrigerant may contain 1 wt % or more of 1,1,2-trifluoroethylene, or may consist of only 1,1,2-trifluoroethylene. That is, the above refrigerant may contain 1 wt % to 100 wt % of 1,1,2-trifluoroethylene.

For example, the above refrigerant may contain 1 wt % or more of 1,2-difluoroethylene, or may consist only of 1,2-difluoroethylene. That is, the above refrigerant may contain 1 wt % to 100 wt % of 1,2-difluoroethylene.

The above refrigerant may be a mixture of 1,1,2-trifluoroethylene and difluoromethane (also referred to as R32). For example, a mixture of 40 wt % of 1,1,2-trifluoroethylene and 60 wt % of R32 can be used as the refrigerant. R32 of this mixture may be replaced by another substance. For example, a mixture of 1,1,2-trifluoroethylene and another ethylene-based hydrofluorocarbon may be used as the refrigerant. Examples of another ethylene-based hydrofluorocarbon include fluoroethylene (also referred to as HFO-1141), 1,1-difluoroethylene (also referred to as HFO-1132a), trans-1,2-difluoroethylene (also referred to as “HFO-1132(E)”), and cis-1,2-difluoroethylene (also referred to as “HFO-1132(Z)”).

R32 may be replaced by any one of 2,3,3,3-tetrafluoropropene (also referred to as R1234yf), trans-1,3,3,3-tetrafluoropropene (also referred to as “R1234ze(E)”), cis-1,3,3,3-tetrafluoropropene (also referred to as “R1234ze(Z)”), 1,1,1,2-tetrafluoroethane (also referred to as “R134a”), and 1,1,1,2,2-pentafluoroethane (also referred to as R125). R32 may be replaced by a mixture composed of two or more of, for example, R32, R1234yf, R1234ze(E), R1234ze(Z), R134a, and R125.

In the compressor 500, the discharge valve opens when the internal pressure of the refrigerant in the cylinder chamber 503 reaches the specified pressure due to the compression of the refrigerant in the cylinder 502, and the refrigerant is discharged into the sealed container 507. If there is a time lag from when the internal pressure in the cylinder chamber 503 reaches the specified pressure to when the discharge valve is completely open, the internal pressure in the cylinder chamber 503 may exceed the specified pressure. This phenomenon is referred to as pressure overshoot.

As the torque ripple of the motor 100 increases, the instantaneous rotational speed of the motor 100 increases, and therefore the instantaneous internal pressure in the cylinder chamber 503 is more likely to rise and pressure overshoot is more likely to occur. When the pressure overshoot occurs, the refrigerant containing the substance having the property of causing a disproportionation reaction expands in volume. This may lead to the failure of the cylinder 502 in the compressor 500.

In the compressor 500 of the first embodiment, the torque ripple of the motor 100 is reduced as described above, and thus the rotational speed variation of the motor 100 is little. Therefore, the pressure overshoot is less likely to occur. As a result, even when the refrigerant containing the substance having the property of causing a disproportionation reaction is used, the failure of the cylinder 502 can be prevented, and thus a stable operation of the compressor 500 can be enabled.

The refrigerant for the compressor 500 is not limited to the refrigerant containing the substance having the property of causing a disproportionation reaction, but other refrigerants, such as R410A, R407C or R22, for example, may be used. From viewpoint of preventing global warming, a refrigerant with a low level of GWP (global warming potential) is desirable. Examples of the usable low GWP refrigerant include the following refrigerants.

(1) First, a halogenated hydrocarbon having a carbon-carbon double bond in its composition, for example, HFO (Hydro-Fluoro-Olefin)-1234yf (CF₃CF═CH₂), can be used. The GWP of HFO-1234yf is 4.

(2) Alternatively, a hydrocarbon having a carbon-carbon double bond in its composition, for example, R1270 (propylene), may be used. The GWP of R1270 is 3, which is lower than that of HFO-1234yf, but R1270 has higher flammability than HFO-1234yf.

(3) A mixture containing at least one of a halogenated hydrocarbon having a carbon-carbon double bond in its composition or a hydrocarbon having a carbon-carbon double bond in its composition may be used. For example, a mixture of HFO-1234yf and R32 may be used. HFO-1234yf described above is a low-pressure refrigerant and thus tends to increase a pressure drop, which may lead to reduction in the performance of the refrigeration cycle (particularly, the evaporator). For this reason, a mixture of the HFO-1234yf with R32 or R41, which has a higher pressure refrigerant than HFO-1234yf, is desirably used in practice.

The compressor 500 is a rotary compressor in this example, but is not limited to the rotary compressor and may be, for example, a scroll compressor.

### (Refrigeration Cycle Device)

FIG. 17 is a diagram illustrating the refrigeration cycle apparatus 400 including the compressor 500 illustrated in FIG. 16. The refrigeration cycle apparatus 400 is an air conditioner in this example, and includes the compressor 500, a four-way valve 401 as a switching valve, a condenser 402 to condense the refrigerant, a decompression device 403 to decompress the refrigerant, and an evaporator 404 to evaporate the refrigerant.

The compressor 500, the condenser 402, the decompression device 403, and the evaporator 404 are connected together by a refrigerant pipe 410 to configure a refrigerant circuit. The refrigeration cycle apparatus 400 includes an outdoor fan 405 facing the condenser 402 and an indoor fan 406 facing the evaporator 404.

The operation of the refrigeration cycle apparatus 400 is as follows. The compressor 500 compresses the sucked refrigerant and sends out the compressed refrigerant as a high-temperature and high-pressure refrigerant gas. The four-way valve 401 switches the flow direction of the refrigerant. During a cooling operation, the refrigerant set out from the compressor 500 flows to the condenser 402 as illustrated in FIG. 17.

The condenser 402 exchanges heat between the refrigerant sent out from the compressor 500 and the outdoor air supplied by the outdoor fan 405 to condense the refrigerant and then sends out the condensed refrigerant as a liquid refrigerant. The decompression device 403 expands the liquid refrigerant sent out from the condenser 402 and then sends out the expanded refrigerant as a low-temperature and low-pressure liquid refrigerant.

The evaporator 404 exchanges heat between the low-temperature and low-pressure liquid refrigerant sent out from the decompression device 403 and the indoor air to evaporate the refrigerant and then sends out the evaporated refrigerant as the refrigerant gas. Air from which heat is removed in the evaporator 404 is supplied to the interior of a room by the indoor fan 406.

During a heating operation, the four-way valve 401 delivers the refrigerant sent out from the compressor 500 to the evaporator 404. In this case, the evaporator 404 functions as a condenser, while the condenser 402 functions as an evaporator.

The refrigeration cycle apparatus 400 is an air conditioner in this example, but is not limited to the air conditioner and may be a refrigerator or the like.

### Effects of Embodiment

As described above, in the first embodiment, the flux barrier 12 is formed at the end of the magnet insertion hole 11 in the circumferential direction, and at least a part of the flux barrier 12 is located on the outer circumference 15 side of the magnetic pole face 21 of the permanent magnet 20. The groove portion 16 is formed on the inter-pole portion M side of the flux barrier 12, and the groove portion 16 faces the flux barrier 12 in the circumferential direction. Furthermore, the flux barrier 12 has the concave portion A formed on the inner side of the groove portion 16 in the radial direction.

Thus, the magnetic flux flowing from the permanent magnet 20 to the inter-pole portion M side flows between the groove portion 16 and the concave portion A (second thin-walled portion T2), and therefore it flows in the direction away from the tooth tip portion 52a of the tooth 52. Thus, short circuit of the magnetic flux between the magnetic poles of the rotor 1 through the tooth tip portion 52a of the tooth 52 is less likely to occur. As a result, torque ripple can be reduced, and vibration of the motor 100 can be suppressed.

The flux barrier 12 has the first side 12a extending along the outer circumference 15, the second side 12b extending inward in the radial direction from the end of the first side 12a on the groove portion 16 side, and the third side 12c extending from the inner end of the second side 12b toward the inter-pole portion M side.

Thus, the path for the magnetic flux in the radial direction is formed between the second side 12b of the flux barrier 12 and the side portion 16b of the groove portion 16. Since the magnetic flux flows through this path, the magnetic flux flows in the direction away from the tooth tip portion 52a of the tooth 52. This can enhance the effect of reducing torque ripple.

Since the depth D of the groove portion 16 in the radial direction is larger than the distance between the outer circumference 15 and the first side 12a (i.e., the width L1 of the first thin-walled portion T1), the magnetic flux directed from the permanent magnet 20 to the inter-pole portion M side can be made to flow more effectively in the direction away from the tooth tip portion 52a of the tooth 52. This can further enhance the effect of reducing torque ripple.

The first thin-walled portion T1 is formed between the first side 12a and the outer circumference 15, and the width of the first thin-walled portion T1 is thinner than the sheet thickness of each steel sheet of the rotor core 10. Thus, the magnetic flux exiting from the magnetic pole face 21 can be prevented from flowing toward the inter-pole portion M side during the normal operation. Further, the magnetic flux exiting from the magnetic pole face 21 can be prevented from flowing to the teeth 52 during the field-weakening control.

The width L2 of the second thin-walled portion T2 between the third side 12c and the groove portion 16 is wider than the width L1 of the first thin-walled portion T1. Thus, the magnetic flux passing through the first thin-walled portion T1 is more likely to flow to the second thin-walled portion T2 rather than the tooth tip portion 52a of the tooth 52. This can enhance the effect of reducing torque ripple.

The groove portion 16 is formed at the position that does not overlap the permanent magnet 20 in the radial direction, and thus the flow of magnetic flux is not obstructed by the groove portion 16 during the normal operation. Consequently, a reduction in the output torque of the motor 100 can be suppressed.

The groove portion 16 is located on the outer side of the virtual circle C2 that passes through the points of the permanent magnets 20 located farthest from the axis Ax, and thus it is possible to suppress short circuit of the magnetic flux between the magnetic pole faces 21 and 22 of the same permanent magnet 20.

The second convex portion 14 as a positioning portion is formed adjacent to the flux barrier 12, and thus the permanent magnet 20 can be positioned so as not to move within the magnet insertion hole 11.

Since the motor 100 with less torque ripple is used as the drive source of the compressor 500, the output variation of the compressor 500 can be suppressed.

Since the output variation of the compressor 500 is suppressed, stable operation of the motor can be achieved even when the refrigerant that may cause a disproportionation reaction, such as a refrigerant containing an ethylene-based hydrofluorocarbon (specifically, R1123), is used.

By using the motor 100 with less torque ripple, vibration in the compressor 500 can be suppressed, and thus the quietness of the refrigeration cycle apparatus 400 can be enhanced.

Although the desirable embodiments of the present disclosure have been specifically described above, the present disclosure is not limited to the above embodiments, and various modifications or changes can be made to those embodiments without departing from the scope of the present disclosure.

1. A rotor comprising:
a rotor core having an outer circumference extending in a circumferential direction about an axis, and having a magnet insertion hole located on an inner side of the outer circumference in a radial direction about the axis; and
a permanent magnet inserted in the magnet insertion hole,
wherein the rotor core has a flux barrier at an end of the magnet insertion hole in the circumferential direction,
wherein at least a part of the flux barrier is located on the outer circumference side of a magnetic pole face of the permanent magnet,
wherein a positioning portion that positions the permanent magnet in the magnet insertion hole is formed adjacent to the flux barrier,
wherein, in the rotor core, an inter-pole portion is defined on an outer side of the magnet insertion hole in the circumferential direction,
wherein a groove portion is formed on the inter-pole portion side of the flux barrier in the circumferential direction, the groove portion being recessed from the outer circumference inward in the radial direction,
wherein the groove portion faces the flux barrier in the circumferential direction,
wherein the flux barrier has a concave portion formed on an inner side of the groove portion in the radial direction, and
wherein the concave portion is located between the positioning portion and the groove portion.

2. The rotor according to claim 1, wherein the flux barrier has:
a first side extending along the outer circumference,
a second side extending inward in the radial direction from an end of the first side closer to the groove portion, and
a third side extending from an inner end of the second side in the radial direction and facing the groove portion in the radial direction.

3. The rotor according to claim 2, wherein a depth of the groove portion in the radial direction is larger than a distance between the outer circumference and the first side.

4. The rotor according to claim 2, wherein the groove portion has a bottom portion on an inner side relative to the first side in the radial direction and on an outer side relative to the third side in the radial direction.

5. The rotor according to claim 2, wherein a first thin-walled portion is formed between the first side and the outer circumference.

6. The rotor according to claim 5, wherein the rotor core has a stacked body in which steel sheets are stacked, and
wherein a width of the first thin-walled portion in the radial direction is thinner than a sheet thickness of each of the steel sheets.

7. The rotor according to claim 5, wherein a second thin-walled portion is formed between the third side and the groove portion, and
wherein a width of the second thin-walled portion in the radial direction is wider than a width of the first thin-walled portion in the radial direction.

8. The rotor according to claim 1, wherein the groove portion is formed at a position that does not overlap the permanent magnet in the radial direction.

9. The rotor according to claim 1, wherein the groove portion is located outside a virtual circle that passes through a point of the permanent magnet farthest from the axis.

10. The rotor according to claim 2,
wherein the positioning portion has a side facing the third side in the radial direction.

11. The rotor according to claim 1, wherein the rotor core has at least one slit on an outer side of the magnet insertion hole in the radial direction.

12. A motor comprising:
the rotor according to claim 1; and
a stator surrounding the rotor from outside in the radial direction.

13. A compressor comprising:
the motor according to claim 12; and
a compression mechanism driven by the motor.

14. The compressor according to claim 13, wherein a refrigerant containing a substance having a property of causing a disproportionation reaction is used.

15. The compressor according to claim 14, wherein the substance is an ethylene-based hydrofluorocarbon.

16. The compressor according to claim 14, wherein the substance is 1,1,2-trifluoroethylene.

17. The compressor according to claim 14, wherein the substance is 1,2-difluoroethylene.

18. A refrigeration cycle apparatus comprising:
the compressor according to claim 13, a condenser, a decompression device, and an evaporator.

19. The refrigeration cycle apparatus according to claim 18, further comprising a controller that controls rotation of the motor using field-weakening control.
